(19) United States
(12) Patent Application Publication
(10) Pub. No.: US 2002/0157371 A1
(43) Pub. Date: Oct. 31, 2002

(54) Tine element and agricultural machinery

(75) Inventor: Alfonsus Jacobus Van Den Engel, Schiedam (NL)

Correspondence Address: Penrose Lucas Albright, Esq.,, MASON, MASON & ALBRIGHT, P.O. Box 2246, Arlington, VA, 22202-0246, US

(73) Assignee: MAASLAND N.V. A DUTCHLIMITED LIABILITY CO.

(21) Appl. No.: 09/814,937

(22) Filed: Mar. 23, 2001

Related U.S. Application Data
(63) Continuation of application No. PCT/NL00/00511, filed on Jul. 20, 2000.

(30) Foreign Application Priority Data
Jul. 24, 1999 (DE) 29912957.8

(51) Int. Cl. A01D 80/02

(52) U.S. Cl. 56/375; 56/400; 56/400.21; 56/365; 172/705

(57) ABSTRACT

A tine element which is installed on a rake wheel of an agricultural implement which displaces harvested products such as hay and cut grass, the tine element comprising a first and second tine with the outboard end of each tine being disposed so that it points normal to the direction of travel of the tine element around the axis of the rake wheel. Each of the tines has on its inboard end a coiled part and such coiled parts are joined by a common central part. In operation, one of the tines is disposed above the other tine with the lower tine being longer than the upper tine. The coiled parts comprise coil torsion springs and each part has different elasticity characteristics so that the resilient deflection of the lower tine is greater than the relative deflection of the upper tine and the flexibility of the each tine is optimized to obtain better adaptation to the ground and to provide a longer life span for the tine element.

### RELATED APPLICATION

This Application is a Continuation of International Application No. PCT/NL00/00511, filed Jul. 20, 2000.

### FIELD OF THE INVENTION

The invention relates to a tine element for displacing harvest products. Such an element, for example, has been described in the German patent specifications 1 507 295 and 17 82 058. The curved hook-shaped tine ends ensure that the hay or other harvest product lying on the ground that is to be displaced during tedding or raking movements is satisfactorily picked up and moved by the tine ends. During operation, the outboard end of one of the tine parts contacts the ground in its lowest position. This causes repeated high stress of this tine which in turn reduces the life span of the entire element.

### BACKGROUND OF THE INVENTION

Similar elements of various material strengths or differing numbers of coils are known and conventional. Such conventional tine elements do not provide considerable accommodations to the ground through flexibility or resilience of the lower tine because this unduly impairs its pick-up and carrying capacity, and thus the performance of the pair of tines.

### SUMMARY OF THE INVENTION

An object of the present invention is an improved tine element. This is accomplished by providing torsion spring coils which respectively control the two tines with different characteristics which control their resilience based on the circumstance that in the case of tine elements which operate under tension it is possible to achieve better accommodation to the ground and an increased life span by optimizing the resilient characteristics of the individual tines of a pair of tines, while performing satisfactorily at the same time. At the same time the curved tine end guarantees an excellent working performance, even with the tines being less rigid.

### BRIEF DESCRIPTION OF THE DRAWINGS

Other objects, adaptations and capabilities will appear as the description progresses, reference being had to the accompanying drawing in which:

FIG. 1 is a diagrammatic side view of a tine element that is fastened to a bracket of a hay-making machine;

FIG. 2 is a diagrammatic view of the tine as seen in the direction of arrow II in FIG. 1;

FIG. 3 is diagrammatic view of another tine element;

FIG. 4 is a diagrammatic depiction of a tine element during operation; and

FIG. 5 is a diagrammatic view of the tine element as seen in the direction of arrow V in FIG. 4.

### BRIEF DESCRIPTION OF THE PREFERRED EMBODIMENTS

FIG. 1 shows a diagrammatic side view of a tine element 1 that is fastened to a hay-making machine in accordance with one embodiment of the invention. Tine element 1 serves the purpose of displacing (picking up, carrying and then laying down) harvest products such as hay lying on the ground, the tine element being incorporated in a tedding machine or a raking machine. By fastening tine element 1 appropriately on the respective hay-making machine, it can be used both for tedding and for raking purposes.

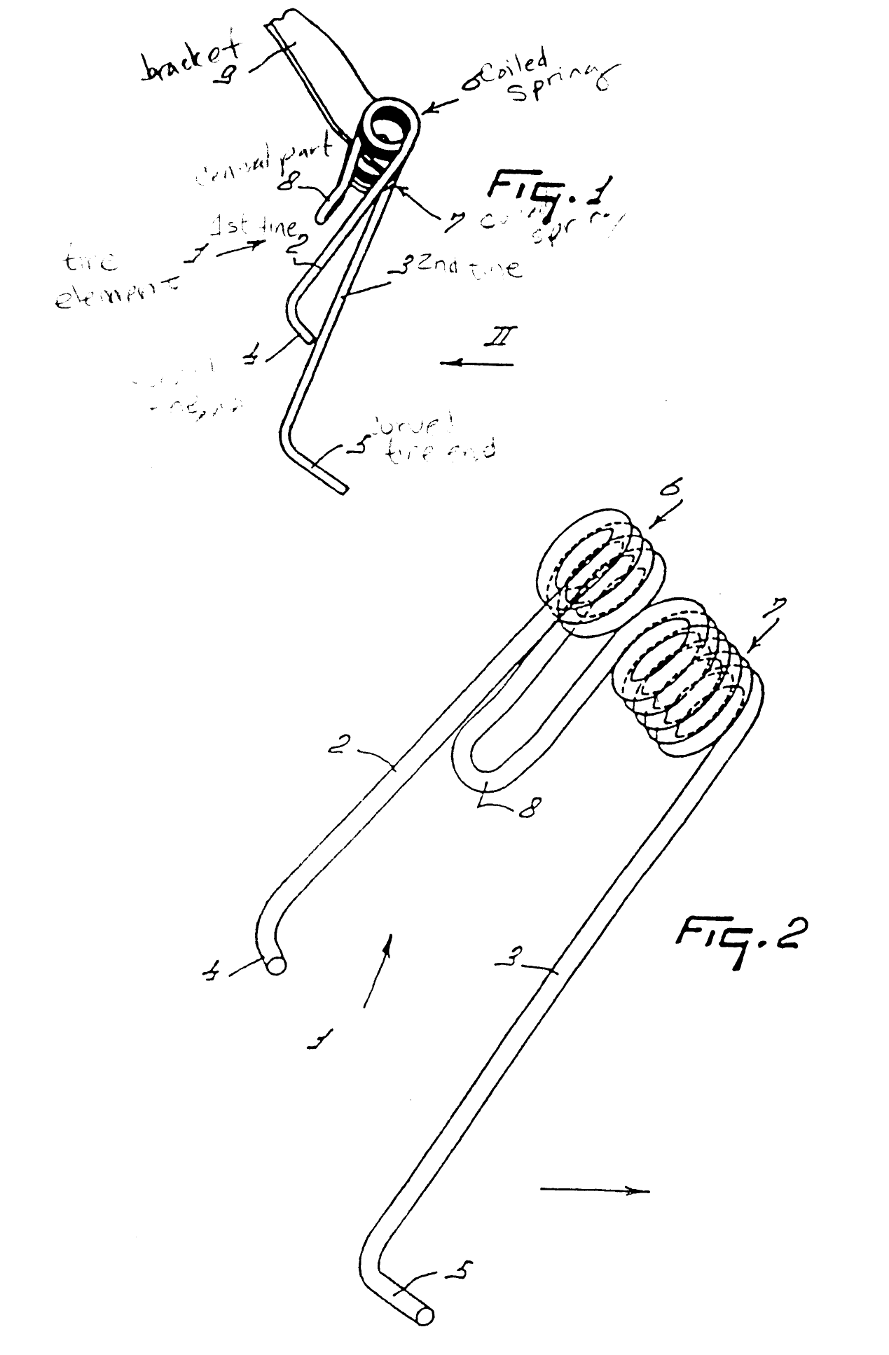

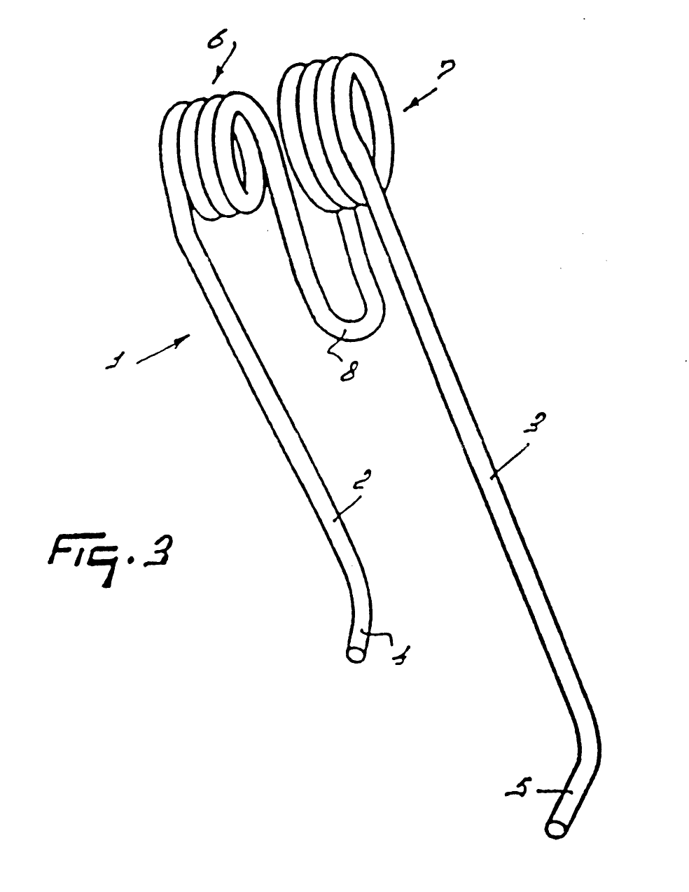

Tine element 1 is equipped with a first and a second tine 2 and 3. These tines 2 and 3 are straight for the most part; however they have an outboard curved tine end 4 and 5, respectively, so as to be suited to carry the harvest products during operation by means of a pulling movement (carrying it like a rake). They are joined by a common central part 8 which interconnects coil spring-shaped parts 6 and 7, respectively. First and second tines 2 and 3 have different lengths in the example shown. Tine element 1 is fastened to a bracket 9 of a hay-raking machine. When tedding or raking, the movements of bracket 9, and thus of tine element 1, are basically known. The hay-raking machine, being is conventional, is not explained further. In FIG. 2, a diagrammatic view of tine element 1 as seen in the direction of the arrow II in FIG. 1 is shown.

Coiled parts 6 and 7 are designed so that they provide the tines 2 and 2 with different elasticity characteristics (pliability, elasticity, flexibility, rigidity, rigidness). In the embodiment shown, coiled parts 6 and 7 have different numbers of coils. Coiled part 7 of the longer tine 3 has more coils (preferably one or two more) than coiled part 6 of the shorter tine 2. This way the longer tine 3 is less rigid whereby its accommodation for the ground is improved. The shorter tine 2, however, maintains its rigidity. Although the longer tine's 3 ability to pick up and carry harvest products may appear to be slightly impaired due to its increased flexibility, its hook-shaped tine end 5 still ensures excellent performance. This is possible because tine ends 4 and 5 are bent so that each of the pair of tines 2 and 3 works through pulling movements (carrying movements like a rake). The life span of the pair of tines 1 is considerably longer than that of a conventional tine element not having features in accordance with the invention.

In accordance with another embodiment (not shown), different degrees of material strength or material hardness are used on a tine element. Coiled part 7 or tine 3 (at least in part or both) can be manufactured from a thinner or less rigid material. In a preferred version, tine element 1 is manufactured as one piece (for example from a single piece of spring steel wire). This way, manufacturing is not more expensive. Differing degrees of hardness can also be achieved in a single-piece element 1 in a familiar fashion by treating the material appropriately.

Additionally, the material of which the coiled parts 6 and 7 are composed can have different cross-sections or different material properties or both on the one coiled part 6, at least in part, than on the other coiled part 7. Tine element 1 can also be produced from different alloys.

In a preferred version, outboard curved ends 4 and 5 form an angle of about 80° to 90° with the respective tines 2 and 3. In this way superior results are achieved.

FIG. 3 depicts a diagrammatic view of another tine element 3. Coiled parts 6 and 7 basically form cylindrical parts wherein the diameters of these cylindrical parts (actually the diameters of the two coils) differ from each other. Due to the forces exerted on tine ends 4 and 5, lower tine 3 during operation better accommodates to the ground without adversely affecting its performance.

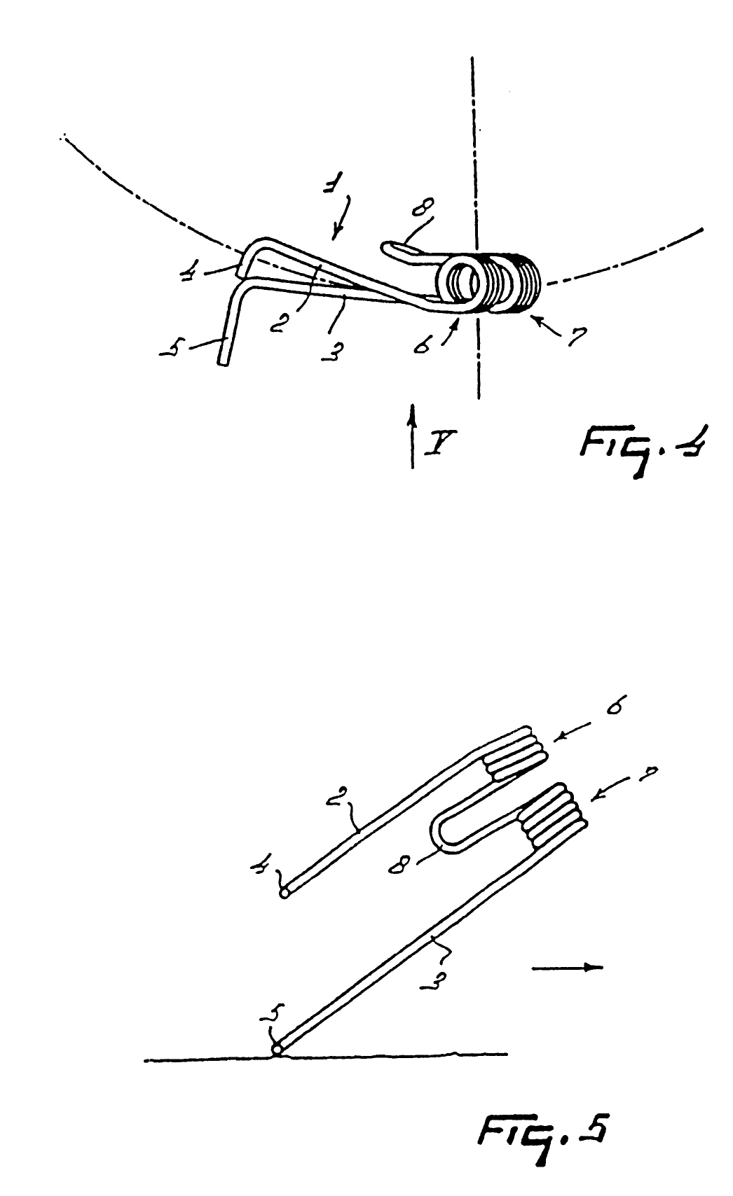

FIGS. 4 and 5 illustrate the operation of a tine element 1. Tine parts 2 and 3 are roughly aligned in their direction of movement, and tine ends 4 and 5 move the harvest products (not shown). It will thus be understood that the tensile forces exerted by the tines are mostly effective in the direction of movement so that the flexibility of lower tines 3, which is increased relative to the direction of movement, does not impair that tine's performance.

Although I have described the preferred embodiments of my invention, it is to be understood that it is capable of other adaptations and modifications within the scope of the following claims.

1. Tine element (1) for displacing harvest product, comprising a first (2) and a second (3) tine, each linked by a coiled part (6, 7) to a common central part (8), wherein at least one tine (2, 3) has a curved end (4, 5), which can, during operation, drive in traction to harvest product, characterized by the fact that the coiled parts (6, 7) are designed so that they provide to the tines (2, 3) different elasticity characteristics.

2. Tine element in accordance with claim 1, characterized by the fact that the coiled parts (6, 7) have differing numbers of coils.

3. Tine element in accordance with claim 1 or 2, characterized by the fact that the coiled part (7) of a longer tine (3) has more coils than that (6) of a shorter coiled part (2).

4. Tine element (1) in accordance with one of the claims 1 through 3, characterized by the fact that the one coiled part (7) has one or two more coils than the other coiled part (6).

5. Tine element (1) in accordance with one of the claims 1 through 4, characterized by the fact that the coil-shaped parts (6, 7) basically form a cylindrical part, wherein the diameters of these cylindrical parts differ from each other.

6. Tine element (1) in accordance with one of the claims 1 through 5, characterized by the fact that the material of which the coiled parts (6, 7) consist can have a diameter of differing size on one coiled part (6), at least in part, than on the other coiled part (7).

7. Tine element (1) in accordance with one of the claims 1 through 6, characterized by the fact that the material of which the coiled parts (6, 7) consist has differing material properties on one coiled part (6), at least in part, than on the other coiled part (7).

8. Tine element (1) in accordance with one of the claims 1 through 7, characterized by the fact that the material of which the coiled parts (6, 7) consist has differing degrees of hardness on one coiled part (6), at least in part, than on the other coiled part (7).

9. Tine element (1) in accordance with one of the claims 1 through 8, characterized by the fact that it is one piece.

10. Tine element (1) in accordance with one of the claims 1 through 8, characterized by the fact that it is made of different alloys.

11. Tine element (1) in accordance with one of the claims 1 through 10, characterized by the fact that the curved tine end (4, 5) encloses an angle of about 80° to 90° with the appropriate tine (2, 3).

12. Agricultural machinery with a tine element (1) in accordance with one of the claims 1 through 11.
